(19) United States
(12) Patent Application Publication
(10) Pub. No.: US 2018/0247270 A1
(43) Pub. Date: Aug. 30, 2018

(54) THEME PARK MANAGEMENT SYSTEM

(71) Applicant: Panasonic Intellectual Property Management Co., Ltd., Osaka (JP)

(72) Inventors: John CRONIN, Bonita Springs, FL (US); Michael Glynn D'ANDREA, Burlington, VT (US)

(21) Appl. No.: 15/906,613

(22) Filed: Feb. 27, 2018

Related U.S. Application Data
(60) Provisional application No. 62/464,843, filed on Feb. 28, 2017.

(51) Int. Cl. G06Q 10/10

(52) U.S. Cl. CPC G06Q 10/109

(57) ABSTRACT

Embodiments for monitoring ride conditions at theme parks in order to provide predictions when maintenance and/or expected downtime may occur. The monitored ride conditions are also used alongside information obtained from tracking patrons and predicted activity at the theme park in order to provide predictions for wait times at the various attractions. The predictions for maintenance and wait times can be displayed for the patrons. Furthermore, these predictions also provide the embodiments of the present application the ability to identify alternative attractions for situations where the predicted wait time for the attraction is too long. In this way, patrons may be able to schedule their trip at the theme park to take advantage of various attractions when the wait times are lower.

### RELATED APPLICATIONS

This application claims priority to U.S. provisional application No. 62/464,843 filed on Feb. 28, 2017, the entire contents of which are incorporated herein by reference.

### BACKGROUND

### Field of Invention

The present disclosure generally relates to time management systems. In particular, the present disclosure relates to theme park ride management systems.

### Description of the Related Art

Many theme parks have various attractions that include various rides (e.g. roller coasters). These rides may have varying wait times based on various factors such as how popular the ride is and throughput for the ride for a period of time. However, maintenance and downtime can also cause rides to operate at slower throughput. There is a need to provide estimated wait times for users for particular rides. Furthermore, there is a need to provide users with alternative rides for situations where the wait time for a current ride is too long.

### SUMMARY OF THE CLAIMED INVENTION

Embodiments of the present invention include systems and methods directed towards managing theme park rides. In particular, the embodiments are directed at providing alternative attractions for patrons in situations where certain attractions that the patron planned on attending have long wait times. The embodiments utilize patron activity, traffic associated with the attractions and attraction conditions in order to calculate wait times for each attraction. These wait times are provided to the patron's user device to be viewed or at kiosks associated with the attractions. Based on the patron's schedule and preferences about wait times, embodiments can also suggest alternative attractions that have shorter wait times.

### BRIEF DESCRIPTION OF THE DRAWINGS

FIG. 1 illustrates an example theme park ride management system.

FIG. 2 illustrates an example theme park network.

FIG. 3 illustrate a block diagram of an example attraction traffic optimization software.

FIG. 4 illustrate a block diagram of an example wait time estimation software.

FIG. 5A and FIG. 5B illustrate example user device graphical user interfaces.

FIG. 6 illustrates an exemplary computing system (i.e. user device) that may be used to implement an embodiment of the present invention.

FIG. 7 illustrates an example attraction kiosk display.

### DETAILED DESCRIPTION

The present application describes systems and methods for monitoring ride (e.g. rollercoasters) conditions at theme parks in order to provide predictions when maintenance and/or expected downtime may occur. The monitored ride conditions are also used alongside information obtained from tracking patrons and predicted activity at the theme park in order to provide predictions for wait times at the various attractions.

The predictions for maintenance and wait times can be displayed for the patrons. Furthermore, in some embodiments, these predictions also provide the ability to identify alternative attractions for situations where the predicted wait time for the attraction is too long. In this way, patrons may be able to schedule their trip at the theme park to take advantage of various attractions when the wait times are lower. The term “attraction” as used herein refers to an area of interest to patrons at a theme park. Various areas of interest to patrons include, but are not limited to, rides, vendors, performance stages, characters for patrons to take photographs with, exhibits, etc. The “theme park” as used herein refers to a location where several areas of interest are made available to patrons in an enclosure. While the following description relates to management of theme parks, it is contemplated that the embodiments described herein are also applicable locations such as museums, botanical gardens, etc. and events such as seasonal fairs (e.g., renaissance fair, county fair, etc.).

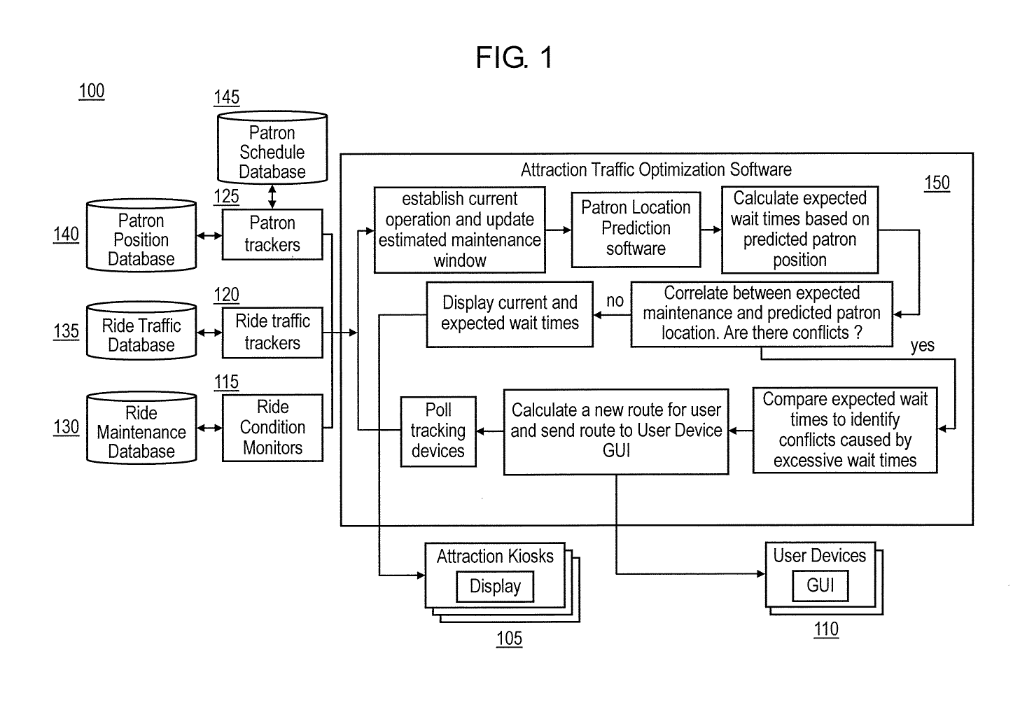

FIG. 1 illustrates an example theme park attraction management system 100. The theme park attraction management system 100 monitors attraction conditions, traffic, and patron activity in order to provide estimated wait times for the patrons to view, for example, on kiosks 105 associated with rides or on patron's respective user devices 110. The attraction conditions are used to also predict upcoming maintenance and/or expected downtime that can also similarly be provided to the patrons to view.

Attraction conditions, attraction traffic and patron activity information is obtained respectively using attraction condition monitors 115, attraction traffic trackers 120, and patron trackers 125. The information can be stored in their respective databases 130, 135 and 140. Examples of patron trackers include, but are not limited to, pagers provided to the patrons, RF-tagged cards provided to the patrons, applications on patrons' mobile devices, etc. Examples of attraction traffic trackers include, but are not limited to, cameras and/or IR sensors in the vicinity of the attractions, turnstile counters at the entrance of the attractions, etc. Examples of condition monitors include sensors and/or processors coupled to individual attractions to monitor the condition of the individual attractions. For example, in case of a roller-coaster attraction, the condition monitors may include sensors to monitor the condition of the electromagnetic breaking system, sensors to monitor the amount of lubrication available on the track, etc. In some embodiments, the condition monitors also include input devices enabling human operators to provide information relating to various parts of the attraction. For example, in case of a roller-coaster attraction, the human operator may input information relating to track condition following a visual inspection to note of there are unexpected bumps during the ride, etc.

Additional information about patrons can also be stored in the patron schedule database 145. The information stored in the patron schedule database 145 includes schedules relating to what attractions (e.g. rides) each patron may wish to visit and tentatively when each patron may aim to participate in that attraction.

The traffic optimization software 150 utilizes the information regarding the ride condition, ride traffic, and/or patron activities in order to provide wait times to the patrons (at the user devices 110 and/or the kiosks 105). The wait times may include current wait times as well as predicted wait times for a later time period.

The traffic optimization software 150 may continually poll the monitors and tracking devices 115, 120 and 125 for updated information. As new maintenance is scheduled/expected downtime is coming up and patron activity is received, the traffic optimization software 150 can update wait times and routes for the patrons. The term “maintenance,” as used herein, refers to any downtime associated with the attraction. For example, if the attraction is a performance stage, the “maintenance” may include the time at which the artists are rehearsing or taking a break. Likewise, if the attraction is a ride such as a rollercoaster, the “maintenance” may include downtime associated with testing, cleaning, repairs, etc.

Furthermore, routes can also be calculated using the patron activity information (e.g. schedule) by the traffic optimization software 150. These routes can facilitate how the patron to proceed from one attraction to another in a time-efficient manner. Furthermore, the traffic optimization software 150 can also calculate new routes based on current and predicted wait times for a planned attraction and nearby/similar attractions. For example, if a nearby or similar attraction has a lower wait time, the traffic optimization software 150 may provide a notification to the patron indicating such. In this way, the patron may be able to choose to go to another attraction with a lower wait time instead of waiting at the current attraction.

The calculation of new routes based on current and predicted wait times by the traffic optimization software 150 can be customized by each patron using their user device 110. For example, the patron may identify that the wait times for the alternative attraction (e.g. similar or nearby attractions to the current attraction) needs to be shorter by a pre-determined factor. The patron may also identify what attractions would fall under “similar” or “nearby” by providing details regarding classification of attractions that would be considered “similar” or a pre-determined distance to be considered “nearby.”

The calculated new routes can be provided to the patron on the user device 110 automatically based on the information processed by the traffic optimization software 150. The calculated new routes can also be provided to the patron at the user device 110 or at a kiosk 105 upon request.

The user devices 110 may be any computing device known in the art owned by the patron. For example, such computing devices may include smartphones, laptops, and tablets. Alternatively, the user device 110 may include devices specific to the theme park. These user devices 110 may be rented or sold by the theme park and would be compatible with the traffic optimization software 150.

The attraction kiosks 105 are generally computing devices associated with a particular attraction. These kiosks 105 may include a display that provides information to various patrons, for example, a current wait time and/or predicted wait time at a future time. The attraction kiosk may also provide other information such as directions to nearby attractions.

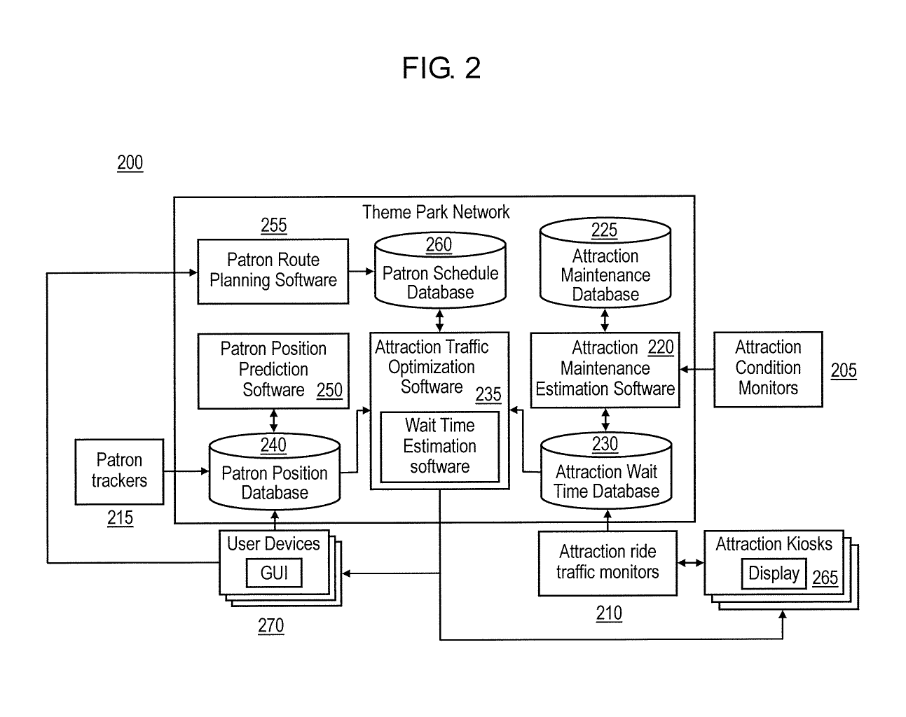

FIG. 2 illustrates an example theme park network 200. The theme park network 200 provides a different view of the theme park ride management system as illustrated in FIG. 1. For example, the theme park network 200 now details how data being obtained via trackers (e.g. patron, attraction traffic, and attraction condition) is stored and transmitted in relation to other components of the theme park network 200 in order to provide the wait times and/or routes to the user devices and/or attraction kiosks.

As illustrated above in FIG. 1, information about attraction conditions, attraction traffic and patrons are obtained via trackers/monitors 205, 210 and 215. The attraction condition monitor 205 tracks the condition of the attraction. Using the information from the attraction condition monitor 205, the attraction maintenance estimation software 220 predicts when maintenance may be needed at a particular attraction. The maintenance estimation software 220 can then schedule the necessary maintenance in order to ensure that the attraction remains operational.

When maintenance is scheduled for the particular attraction, an expected downtime or reduced throughput may be experienced at that attraction. For example, the rollercoaster track may need to be maintained after a pre-determined number of rides in order to ensure that the rollercoaster is functioning properly. Additionally, the individual rollercoaster carts may also need to be maintained after a pre-determined number of rides. Conditions for maintenance used by the attraction maintenance estimation software 220 may be stored in the attraction maintenance database 225.

Based on the type of maintenance needed the operation of the rollercoaster may be affected differently. For example, if individual carts need to be maintained, the rollercoaster may still be operational but with lower throughput. However, if the rollercoaster track needs to be maintained, this may require that the rollercoaster stop operation (or operate at a reduced throughput if multiple tracks are available). Each of these events may translate to a higher than normal wait time.

The estimated wait time caused by the scheduled maintenance can then be stored in the attraction wait time database 230 that stores the estimated wait time for each attraction. The estimated wait time that is provided by the attraction maintenance estimation software 220 can be tagged with the associated attraction so that the appropriate wait time can be retrieved from the database 230 by the traffic optimization software 235 when needed.

Additionally, attraction ride traffic information may be used by the traffic optimization software 235 in calculating estimated wait times. This information corresponds to how busy a particular attraction is. For example, this may be measured by a current throughput of patrons participating in the attraction during a period of time. The throughput may be measured using the attraction ride traffic monitor 210. Furthermore kiosks associated with each attraction 265 can also monitor how many patrons are entering the line for the attraction. When the throughput is calculated, this information is also stored in the attraction wait time database 230.

The patron trackers 215 track the activity of the patrons throughout the theme park. The patron trackers 125 may be situated throughout the theme park in order to capture where patrons are. The information is stored in the patron position database 240. It may also be possible that the user devices 270 owned by each patron can transmit the location of the patron to be stored in the patron position database 240.

The patron position prediction software 250 uses the information stored in the patron position database 240 to predict where patrons may be headed to (i.e. what attractions they will be going towards). This information of where patrons may be at a future time is also stored within the patron position database 240.

The patron position database 240 includes both current and predicted future location of various patrons at the theme park. This information is also provided to the traffic optimization software in order to calculate corresponding wait times. For example, if a lot of patrons are currently in a particular location associated with one or more attractions, those attractions may have longer wait times compared to attractions where less patrons are currently or predicted to be.

Patrons may also plan what attractions they would like to go on using their user devices 270. For example, there may be an application associated with the theme park that allows the patron to identify what rides and in what order they would like to go on. This information can be provided to the patron route planning software 255 that calculates routes between different attractions based on the patron's plans of what rides to go on.

The routes that are calculated by the patron route planning software 255 may be calculated based on various factors. For example, routes between attractions may be generated based on popularity. For example, the patron may be at one attraction and the generated route will direct the patron to the next popular attraction on the patron's plan. The route may also direct the patron to the next favorited attraction on the patron's plans. Information about wait times can also be used to influence what routes are generated based on the patron's plan. For example, the shortest wait times may be chosen as the next destination using the generated routes. Alternatively, routes can alternate between a short wait time and a long wait time. Furthermore, the generated route may direct the patron to the next closest attraction on the patron's plans.

Information about the patron's plans provided from the user devices 270 and the corresponding routes calculated by the patron route planning software 255 can then be stored in the patron schedule database 260. This information can be provided to the traffic optimization software 235.

The traffic optimization software 235 may continually poll for new information from the attraction wait time database 230, the patron position database 240 and the patron schedule database 260 in order to calculate current and predicted wait times for various attractions at the theme park. In some embodiments, the traffic optimization software 235 performs the calculation after a pre-determined period of time regardless of when new information is obtained. The current and predicted wait times calculated by the traffic optimization software 25 can then be provided for the patrons to view on their user device 270 or on an associated kiosk 265.

The current wait times are calculated, for example, based on current location of patrons, scheduled maintenance data and current traffic at each attraction. Predicted wait times are calculated, for example, based on scheduled maintenance data, plans of various patrons as well as historic data associated with the patron activity and attraction ride traffic.

The traffic optimization software 235 can also calculate new routes based on the information that can be stored within the patron schedule database 260 and provided to the patron on their user device 270. The calculated new routes may be triggered for situations where wait times for particular rides exceed a pre-determined threshold. For example, the patron may indicate that they would not like to wait for any ride for longer than an hour. If such a condition is triggered, the traffic optimization software 235 can then proceed to calculate new routes to alternative attractions that the patron can go to instead.

New routes can also be triggered if the patron's plan to go on a particular ride coincides with a scheduled maintenance. Based on the maintenance performed on the attraction, which either causes a downtime for the attraction or increased wait time, the traffic optimization software 235 can also proceed to calculate new routes to alternative attractions that the patron can go to instead.

The alternative attractions that the patron can go to can be automatically suggested by the traffic optimization software 235. Alternatively, the patron can provide preferences determining what type of alternative attraction should be chosen. For example, the alternative attraction can be chosen based on a pre-determined distance from the current attraction. In another situation, the alternative attraction can be chosen based on having a current or predicted wait time that is less a pre-determined amount than wait time at the current attraction. Furthermore, the alternative attraction can be chosen based on similarity to the current attraction.

As noted above, the user device may be any computing device known in the art owned by the patron. For example, such computing devices may include smartphones, laptops, and tablets. Alternatively, the user device 270 may include computing devices specific to the theme park. These user devices 270 may be rented or sold by the theme park to the patron for use in the theme park. The user devices 270 would be compatible with the theme park network.

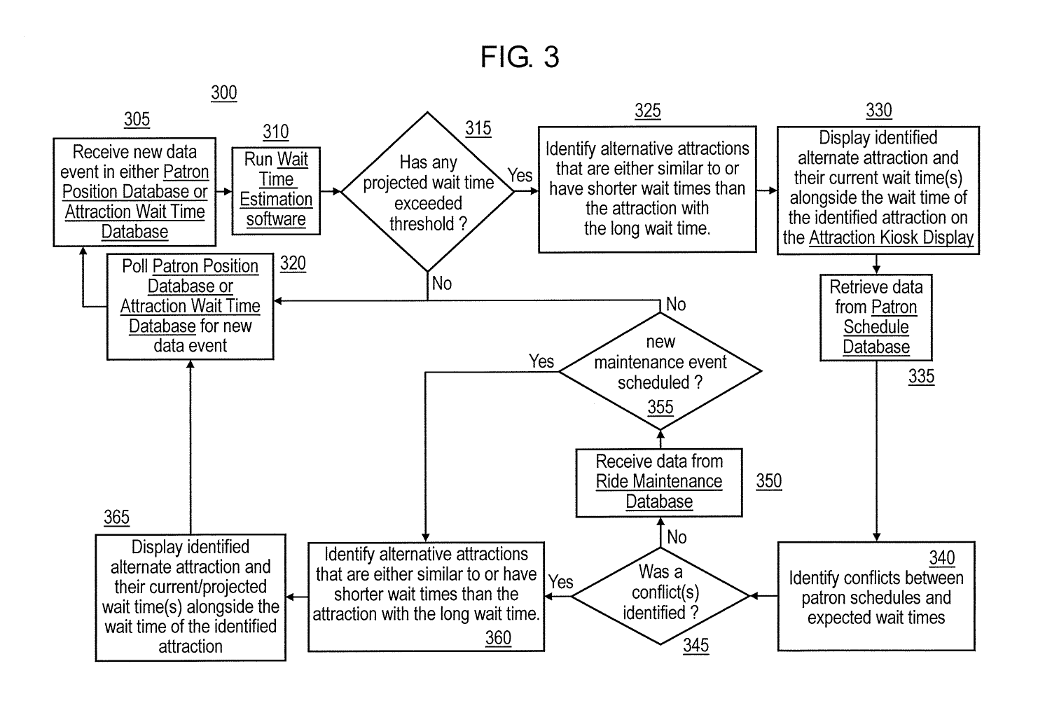

FIG. 3 illustrate a block diagram 300 of an example attraction traffic optimization software. As described above, the attraction traffic optimization software is used to calculate wait times for various attractions based on patron activity, ride traffic and/or scheduled maintenance. The traffic optimization software can also suggest alternative attractions and generate routes to the attraction for the patrons to view on their user devices.

In step 305, the attraction traffic optimization software may receive new data when polling for data that can be used to calculate wait times. The new data may be stored, for example, in the patron position database regarding patron activity. The new data may also include new information from the attraction wait time database regarding estimated wait times caused by maintenance and/or attraction traffic data.

In step 310, the new information is obtained from the applicable database and the wait time estimation software is executed. The wait time estimation software can be used to generate a current wait time based on the information available to the traffic optimization software.

In step 315, a determination is made for each patron (based on their own respective preferences associated with their patron's plan) if the calculated wait time exceeds a pre-determined threshold that is appropriate for that patron. For example, a patron may indicate that they would like to wait no longer than an hour for any attraction. If the calculated wait time is below the pre-determined threshold, the traffic optimization software then resumes polling for new information 320 or recalculates the wait time after a pre-determined period of time.

However, if the calculated wait time in step 310 exceeds the pre-determined threshold, the traffic optimization software can begin identifying alternative attractions for the patron in step 325. Alternative attractions can then be selected. As noted above, alternative attractions can be suggested based on various criteria such as those having shorter wait times or are similar to the current attraction that the patron planned on going on. As noted above, there may be other preferences that the patron can identify that can influence what alternative attractions can be proposed by the traffic optimization software.

In step 330, a list of alternative attractions and their corresponding wait times can be displayed for patrons to view. The list can be provided on a kiosk at the attraction that the patron is currently at where alternative attractions may have been requested by the patron. In other embodiments, the list can be provided on the patron's user device.

In step 335, the traffic optimization software can retrieve patron's plans form the patron schedule database. The patron's plans can then be evaluated in step 340 to see if there are any conflicts between what was previously planned and the calculated wait times. For example, if the calculated wait times are greater than a pre-determined threshold compared to previously predicted wait times considered in the patron's plan, alternative attractions may be needed. The greater than expected wait time can mess up the patron's plans with other attractions.

In step 345 a determination is made to see if any conflicts exist with the calculated wait times compared to the patron's plans retrieved from the patron schedule database. If no conflicts are initially found, the traffic optimization software can retrieve data from the ride maintenance database in step 350 in order to determine if any new maintenance events are schedule in step 355. The maintenance data can be used to also determine if any conflicts exist with the patron's plans. If no maintenance events are scheduled, then the traffic optimization software can return to step 320 and continue polling for new patron and/or wait time data.

However if a conflict is detected in step 345 (because of higher than normal calculated wait times) or step 355 (because of a newly scheduled maintenance event), the traffic optimization software can again identify alternative attractions similar to step 325. The alternative attractions can similarly be displayed for the patron to view in step 365 (similar to step 330). After the alternative routes have been displayed, the traffic optimization software can resume polling for new patron and/or wait time data via step 320.

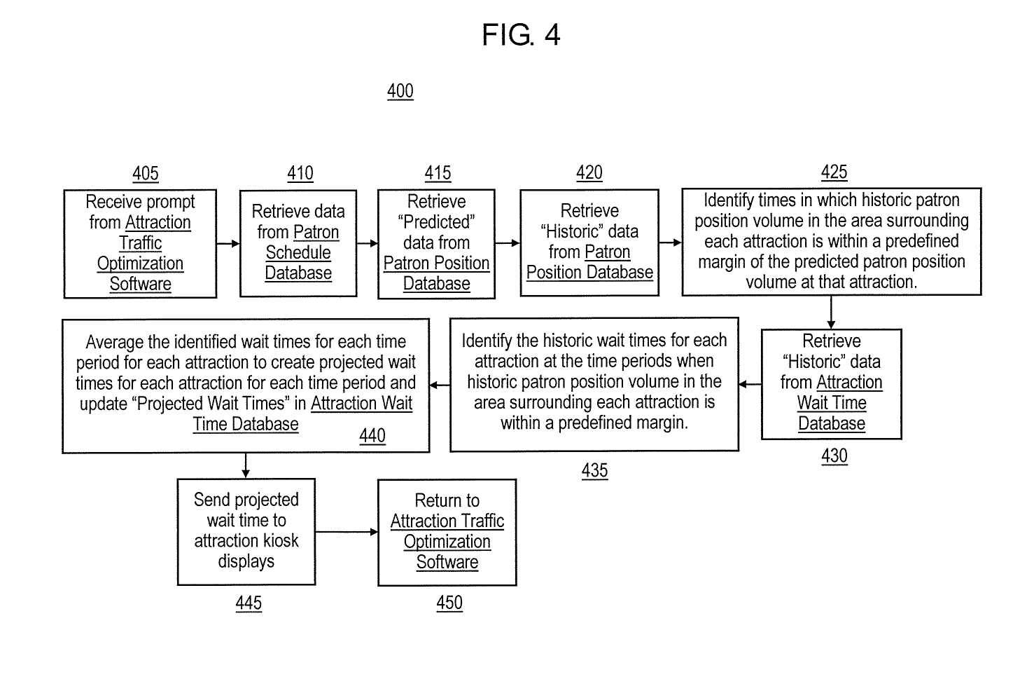

FIG. 4 illustrate a block diagram 400 of an example wait time estimation software. The wait time estimation software uses data regarding patrons, ride traffic and/or scheduled maintenance in order to calculate current wait time and/or predicted wait time for a future period of time. The calculation for current and/or predicted wait times can be performed on a regular basis (i.e. pre-determined time periods) or whenever new patrons, ride traffic and/or scheduled maintenance data is obtained.

In step 405, the wait time estimation software receives a prompt from the traffic optimization software to perform a calculation for current or predicted wait time using information retrieved about the patrons. In step 410, patron's plans from the patron schedule database is retrieved. In step 415, predicted data regarding where patrons are located within the theme park is retrieved from the patron position database. Lastly, in step 420, “historic” data from the patron position database can also be retrieved. “Historic” data corresponds to previously predicted data that characterized patron position at some point in the past. The predictions made and stored in the patron position database may be saved for a pre-determined period of time to be used for use in a “historic” data set.

Using the information retrieved in steps 410-420, the wait time estimation software identifies (in step 425) the times where the historic patron position volume surrounding an attraction is within a pre-determined margin compared to the predicted patron position. In other words, the wait time estimation software can attempt to estimate current wait times based on “historic” wait times using patron position volume data that is similar to the current predicted patron position volume.

In step 430, ‘historic’ data from the attraction wait time database is retrieved. In particular, the ‘historic’ data retrieved would correspond to the times identified in step 425. In step 435, the wait time associated with the ‘historic’ data is retrieved and used (in step 440) to calculate a projected wait time in step 440. The projected wait times are calculated in step 440 by averaging the wait times obtained for various time periods having similar patron position volume in step 435. The projected wait time can then be stored within the attraction wait time database.

In step 445, the projected wait time is provided to the patron for viewing. The projected wait time can be provided to the attraction kiosk associated with the particular attraction the patron is at. Alternatively, the projected wait time can be provided to the patron's user device for viewing. After the projected wait time software has been provided to the patron for viewing, the wait time estimation can indicate to the traffic optimization software (in step 450) that it can resume functionality using the projected wait time information that the projected wait time software calculated.

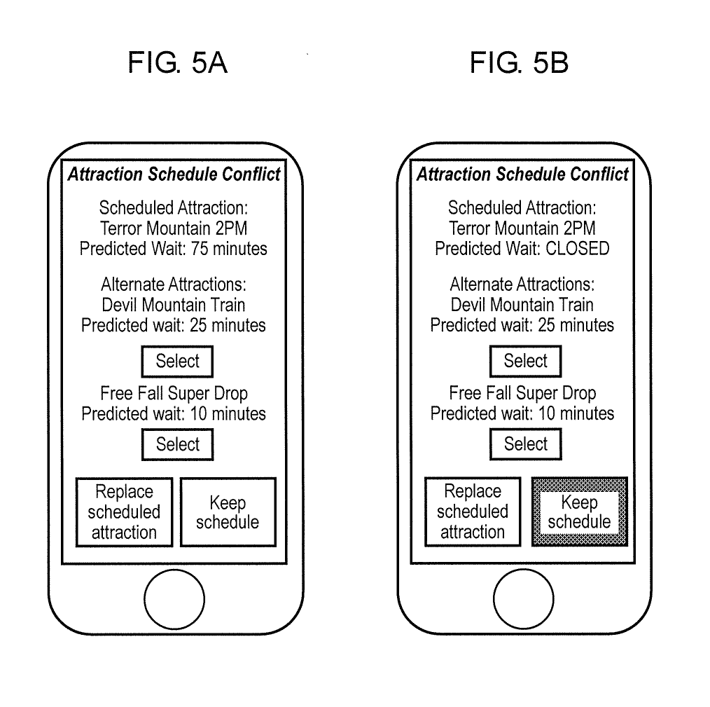

FIG. 5A and FIG. 5B illustrate example user device graphical user interfaces. These graphical user interfaces appear on the patron's user devices to provide relevant information about attractions for the patrons to view. In particular, FIG. 5A and FIG. 5B pertain to graphical user interfaces that provide schedule conflict information.

With reference to FIG. 5A, the graphical user interface illustrates how the display may appear when a conflict that is detected is caused by a wait time. In this example the patron has scheduled a ride on Terror Mountain at 2 PM, but the software described in the present application predicts the wait time at 2 PM to be 75 minutes. The software has identified two alternate rides and displays their projected wait times. The patron can select an alternate attraction and then select the replace scheduled attraction button and the alternate attraction will be added to their schedule in the patron schedule database in place of the scheduled attraction. The patron can also choose to wait in the longer line and in that scenario would select the keep schedule button.

With reference to FIG. 5B, the graphical user interface illustrates how the display may appear when the conflict is due to maintenance being needed on the attraction, as determined by the attraction maintenance estimation software. In this scenario the alternate rides are displayed but the keep schedule button may be grayed out as not selectable if the attraction is experience a downtime (i.e. is closed).

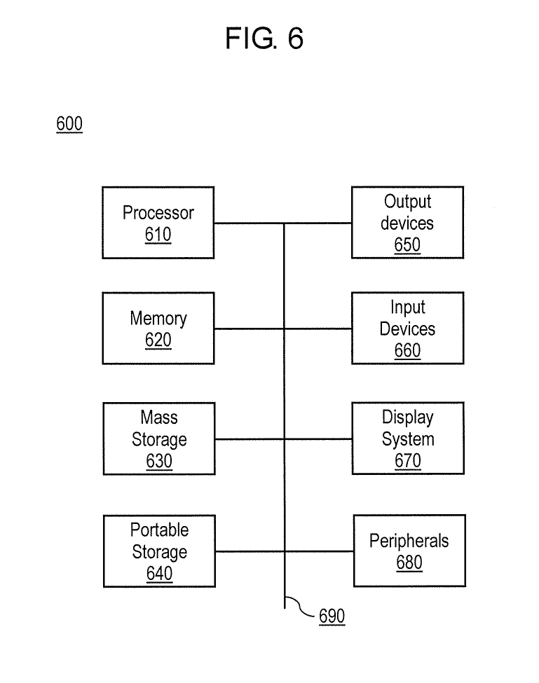

FIG. 6 illustrates an exemplary computing system 600 (i.e. user device) that may be used to implement an embodiment of the present invention. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 840, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable nonvolatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 880 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held user device, telephone, mobile user device, workstation, server, minicomputer, mainframe computer, or any other user device. The computer can also include different bus configurations, networked platforms, multiprocessor platforms, etc. Various operating systems can be used including Unix, Linux, Windows, Macintosh OS, Palm OS, and other suitable operating systems.

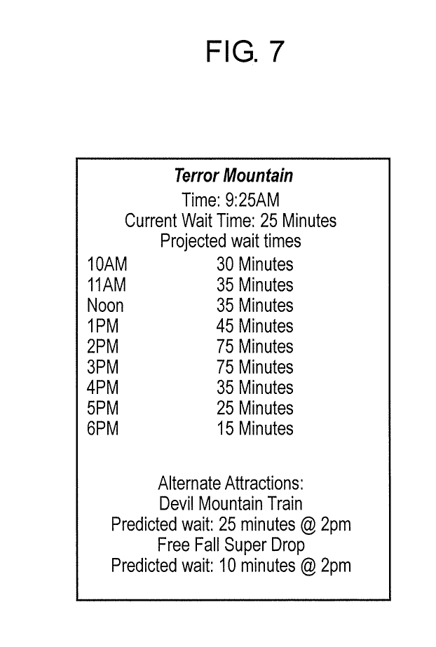

FIG. 7 illustrates an example attraction kiosk display. The kiosk, associated at the entrance of each attraction, can be used to show current wait times and projected wait times for the rest of the day. As illustrated in the FIG. 7, an example display is provided. In this example, the kiosk displays the current wait time as calculated by the attraction traffic monitors and the projected wait times for the rest of the day as calculated by the wait time estimation software for the attraction named Terror Mountain.

Furthermore, the kiosk may also provide alternative actions that may be similar to the current attraction and/or have shorter wait times. For example, the bottom of the kiosk display screen displays the results of the attraction traffic optimization software that provides alternate attraction within a predetermined distance from the attraction (Terror Mountain) and that have shorter wait times.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for managing a theme park, the method comprising:
monitoring, by a patron tracker, patron activity surrounding an attraction;
monitoring, by a traffic tracker, attraction traffic associated with the attraction;
monitoring, by a condition monitor, attraction condition associated with the attraction, wherein the attraction condition includes a schedule of maintenance;
predicting, by a processor, a wait time for the attraction based on information relating to the patron activity, attraction traffic and attraction condition;
receiving, at the processor, input from a user device associated with a patron, wherein the input corresponds to a patron schedule of attractions the patron plans to visit and patron preferences on wait times for the attractions;
determining, using the processor, whether the predicted wait time is greater than the preferred wait time provided by the patron via the received input;
locating, using the processor, alternative attractions having shorter wait times than the predicted wait time for the attraction; and
transmitting, to the user device, information relating to the alternative attractions, thereby enabling the patron to traverse the theme park in a time-efficient manner.

2. The method according to claim 1, further comprising
determining routes from the attraction to the alternative attractions.

3. The method according to claim 1, further comprising:
determining routes to the alternative attractions based on a present position of the patron.

4. The method according to claim 1, wherein the determining whether the predicted wait time is greater than the preferred wait time comprises:
determining expected wait time at the attraction based on the patron schedule and the schedule of maintenance, and
comparing the expected wait time with the patron preferences.

5. The method according to claim 4, wherein the determining whether the predicted wait time is greater than the preferred wait time further comprises;
determining, using the patron tracker, a position of the patron,
estimating a time at which the patron is expected to arrive at the attraction, and
predicting the wait time at the attraction at the time at which the patron is expected to arrive at the attraction.

6. The method according to claim 1, wherein the user device includes a computing device held by the patron or a computing device provided at the theme park.

7. The method according to claim 1, wherein the locating the alternative attractions comprises:
identifying alternative attractions preferred by the patron based on a preference provided by the patron, proximity of each of the identified alternative attractions to the patron's present position, and a predicted wait time at each of the identified alternative attractions.

8. The method according to claim 1, wherein the information relating to the alternative attractions includes current and predicted wait times to each of the alternative attractions, and estimated route to each of the alternative attractions from the attraction and the present position of the patron.

9. A theme park management system comprising:
a patron tracker configured to monitor patron activity at the theme park;
a traffic tracker configured to monitor attraction traffic associated with an attraction in the theme park;
a condition monitor configured to monitor attraction conditions associated with the attraction;
a computer-readable memory for storing information relating to the patron activity, the attraction traffic, and the attraction conditions; and
a processor configured to execute instructions to perform comprising:
predicting a wait time associated with the attraction based on information relating to the patron activity, the attraction traffic, and the attraction conditions,
determining whether the predicted wait time is greater than a preferred wait time for a patron,
identifying alternative attractions having shorter wait times than predicted wait time for the attraction, and
transmitting information relating the alternative attractions,
wherein the information relating to the alternative attractions enables the patron to traverse the theme park in a time-efficient manner.

10. The theme park management system of claim 9, wherein the conditions associated with the attractions include a schedule of maintenance and/or downtime associated with each of the attractions, the type of maintenance or reason for downtime, and an effect of the maintenance and/or downtime on the availability and capacity of each of the attractions.

11. The theme park management system of claim 9, wherein the system further determines routes from the attraction to the alternative attractions.

12. The theme park management system of claim 11, wherein the system determines routes to the alternative attraction based on a present position of the patron.

13. The theme park management system of claim 9, wherein determining whether the predicted wait time is greater than a preferred wait time for a patron comprises querying a patron preference database comprising preference information associated with the patron, the preference information including one or more of preferred wait time, preferred attraction type, a preferred distance between a present position of the patron and a suggested attraction, a list of preferred attractions the patron intends to visit, and a patron schedule according to which the patron intends to visit the preferred attractions.

14. The theme park management system of claim 13, wherein locating the alternative attractions comprises:
identifying alternative attractions preferred by the patron based on the preference information associated with the patron, proximity of each of the identified alternative attractions to the patron's present position, and a predicted wait time at each of the identified alternative attractions.

15. The theme park management system of claim 13, wherein determining whether the predicted wait time is greater than the preferred wait time comprises:
determining expected wait time at the attraction based on the patron schedule and the attraction conditions, and
comparing the expected wait time with the preferred wait time.

16. The theme park management system of claim 15, wherein determining whether the predicted wait time is greater than the preferred wait time further comprises;
determining a present position of the patron,
estimating a time at which the patron is expected to arrive at the attraction, and
predicting the wait time at the attraction at the time at which the patron is expected to arrive at the attraction.

17. The theme park management system of claim 9, the information relating to the alternative attractions includes current and predicted wait times to each of the alternative attractions, and estimated route to each of the alternative attractions from the attraction and the present position of the patron.

18. The theme park management system of claim 9, wherein transmitting the information relating to the alternative locations comprises transmitting the information to a user device, the user device comprising a computing device held by the patron or a computing device provided at the theme park.
